(19) United States
(12) Patent Application Publication
(10) Pub. No.: US 2022/0405811 A1
(43) Pub. Date: Dec. 22, 2022

(54) SYSTEM AND METHOD FOR FUNDRAISING

(71) Applicant: Sean M. Danahy, Scarsdale, NY (US)

(72) Inventor: Sean M. Danahy, Scarsdale, NY (US)

(21) Appl. No.: 17/741,164

(22) Filed: May 10, 2022

Related U.S. Application Data
(60) Provisional application No. 63/159,148, filed on Mar. 10, 2021.

(51) Int. Cl. G06Q 30/02; G06Q 50/00

(52) U.S. Cl. CPC G06Q 30/0279; G06Q 50/01

(57) ABSTRACT

A system and method for fundraising using a social network. The system includes an interface module for generating an interface that allows users to interact with the system; a profile module to create profile of the users, a networking module that allows users to create and populate campaigns to promote a cause for collecting funds, a Fintech module that provides a payment interface, cash accounts, and tracking of the transactions from the donors and to the recipients of charity, an investment module that allows investing cash amount in the cash accounts in investment products for extra gain, a charity module that allows user to transfer funds to the recipients for charity, and a tracking module that tracks the activities of the user for generating rewards.

### CROSS-REFERENCE TO RELATED APPLICATIONS

This application claims priority from the U.S. provisional patent application Ser. No. 63/159,148, filed on Mar. 10, 2021, which is incorporated herein by reference in its entirety.

### FIELD OF INVENTION

The present invention relates to a system and method for fundraising, and more particularly, the present invention relates to a system and method for fundraising using a social network.

### BACKGROUND OF THE INVENTION

Charity and donations to those in need are historically private, momentary, or event-driven for wealthier people. Their lack of organized platforms for fundraising. Known platforms for fundraising are unorganized and have huge management fees which reduce the actual realized amount in charity and donations. Donor-advised funds and investment management options within the asset management and charitable giving space focus largely on the wealthy to gain optimal assets under management amounts, and under-serve donations and fundraising ability of the lower and middle class. Donor-advised funds have also not historically leveraged fundraising, crowdsourcing, gamification, inter-platform/fund gifts, director naming, or sub-account creations—to increase donor engagement.

Known fundraising platforms have high fees and social media are motivated by advertising and user data monetization, therefore are an under-served and under-scoped market for charity, in a society with an infrequent focus on charity. Social media focus on validation, popularity, device addiction, engagement based on outrage, and resulting in the isolation of users. All contribute to the problem this invention aims to solve.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for fundraising using social networking.

It is another object of the present invention that the system and method have a broader demographic reach raising funds from the mass population.

It is still another object of the present invention that the cost of fundraising can be reduced.

It is yet another object of the present invention that the system and method provide an organized and predictable platform for fundraising.

It is a further object of the present invention that the donations can be increased.

It is still a further object of the present invention to remove a historical taboo of discussing charitable moments publicly.

It is yet another object of the present invention is to expand tax favorable investing of a donor-advised and donor-advised fund structure to the common citizen through a simple social media profile/account.

In one aspect, disclosed are a system and method for fundraising. The disclosed system and method can combine businesses across industries to offer an alternative and improved experience over the traditional offerings in each industry alone and respectively. This invention offers a more efficient business model for each component industry to focus on the more selfless aspects of humanity and benefit charity. Ultimately resulting in an increased benefit to the charity sector.

In one aspect, disclosed are a system and method for fundraising, the method implemented within a system comprising a processor and a memory, the method comprising the steps of generating, by an interface module, an interface for interacting with the system; creating, by a profile module implemented with the system and upon execution by the processor, a profile of a user, the profile comprises a name and a contact detail of the user; associating, by a fintech module implemented with the system and upon execution by the processor, one or more cash accounts to the profile for receiving funds from one or more donors; providing, by the fintech module, a payment interface for electronically receiving the funds from the one or more donors; populating, by a networking module, a campaign for presenting a cause to the one or more donors for receiving the funds, wherein the campaign has a unique id, wherein the payment interface is coupled to the campaign; and recording transactions relating to the transfer of funds from the one or more donors in response to the campaign, wherein the transactions are tagged with the unique id of the campaign. The method further comprises the steps of transferring a portion of cash amount from the one or more cash accounts to one or more investment products automatically based on predetermined instructions. The method further comprises the steps of providing an interface for transferring funds to one or more recipients of the charity. The method further comprises the steps of selecting a donor from the one or more donors from whom the funds are transferred to the one or more recipients. The method further comprises the steps of receiving, by the profile module, identification documents, of the user for verification. The method further comprises the steps of providing, by the networking module, a main page associated with the user, the main page comprises the name and the contact detail of the user, information of the campaign, and the transactions associated with the campaign, wherein the transactions are tracked using the unique id of the campaign. The method further comprises the steps of tracking activities of the user in relation to the system; and generating rewards for the contribution of the user based on the activities. The method further comprises the steps of automatically generating receipts for the funds received from the one or more donors to avail of any benefits.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a block diagram showing the architecture of the disclosed system, according to an exemplary embodiment of the present invention.

FIG. 2 is a flow chart illustrating a profile module of the disclosed system, according to an exemplary embodiment of the present invention.

### DETAILED DESCRIPTION OF THE INVENTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe embodiments only and is not intended to be limiting to embodiments of the invention. As used herein, the singular forms “a”, “an” and “the” are intended to include the plural forms as well, unless the context indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed is a system and method for fundraising using social networking. The disclosed system and method can use social media as a platform at its full potential to help people share the feeling of giving and joining others in their hopes to do so. The term social networking herein refers to any method of gathering or contacting a group of people, wherein the members of that group can collect and contribute sums of money for the benefit of a cause, initiative, project, business, philanthropy, or third party. The disclosed system and method can provide for the addition of and alignment with personal goals and gamification over any given length of time. Moreover, the disclosed system and method can also provide for short-term investing of the money held during collection/after donation/or on the platform itself over time but before distribution to the ultimate beneficiary for an additional source of revenue. The disclosed is a social network & fundraising platform that helps users share and interact in charitable moments, with revenue based on the time value of money concepts including but not limited to interest, investment management fees, or donor-advised fund/fee structure earned on donations over time. The disclosed system and method also provide for social media/gamification within a fundraising platform, or a donor-advised fund or platform; user-to-user donations, gifts, sub-account creation on behalf of another user, potential future user, or in honor/name of anyone.

This invention aims to make those events more frequent, more public, and on offer to all wealth categories, including those with no means to be charitable, by requesting fundraising on behalf of a cause from others. It also aims to expand the type of moments in which people are charitable and can do from any location, personal goals at any time, births, bereavements, moments of religious significance, remembrance, life milestones, anniversaries, children's birthdays, holidays, etc. By extending the timeline, frequency, and duration of charitable efforts to near permanent, the platform can forgive charging the same type of fees many fundraising platforms use, and instead leverage the investment income of those funds over that time, thus increasing the percentage of donations that get to the intended beneficiaries. This disclosed platform can be on offer via the internet and/or app to the general population for as close to free as possible, expanding investment and charitable moment optionality to a broader socio-economic demographic than is currently served, and increasing engagement through the internet and social media tools.

The social networking aspect of the disclosed system and method can provide for User stories and fundraising efforts that could become “viral” and inspire sharing, to the extent that some users could gain public notoriety and grow a brand/identity to the extent of good they can produce through a very sharable content on social media.

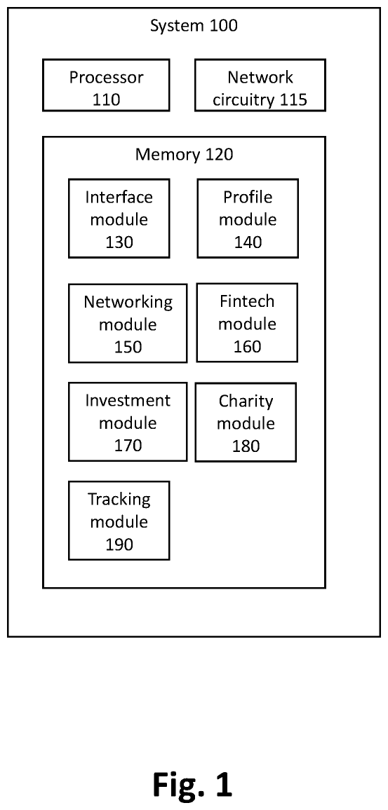

Referring to FIG. 1 shows an exemplary embodiment of the disclosed system 100 that can include a processor 110 and a memory 120. The processor can be any logic circuitry that responds to, and processes instructions fetched from the memory and including microprocessors. The memory may include one or more memory chips capable of storing data and allowing any storage location to be directly accessed by the processor. The system 100 may also include a network circuitry 115 that allows the disclosed system 100 to connect to two or more external devices through a network. The network can be wired or wireless. Moreover, the network can be secured or unsecured. The wired network may include Digital Subscriber Line (DSL), coaxial cable lines, or optical fiber lines. The wireless network may include BLUETOOTH, Wi-Fi, Worldwide Interoperability for Microwave Access (WiMAX), an infrared channel, or a satellite band. The wireless network may also include any cellular network standards used to communicate among mobile devices, including but not limited to standards that qualify as 3G, 4G, or 5G.

The disclosed system through the network can connect different users and potential donors and donee. The disclosed system can be implemented in an environment of a single or multiple, logically grouped servers, the servers include cloud servers. According to an exemplary embodiment, the servers may be geographically dispersed. One or more of the servers can include an operating system platform, for example, Windows, Unix, Linux, or Mac.

The memory of disclosed system 100 can include an interface module 130, a profile module 140, a networking module 150, a Fintech module 160, an investment module 170, a charity module 180, and a tracking module 190. The modules can be software, a functional piece of code in one or more computer-readable languages, a set of instructions, and the like which upon execution by the processor can perform one or more steps of the disclosed methodology.

The interface module 130 upon execution by the processor can provide an interface on an external device for interacting with the disclosed system 100. The profile module 140 upon execution by the processor can create a profile of a user on the disclosed system 100. The networking module 150 upon execution by the processor can provide for creating social networks and groups. The Fintech module 160 upon execution by the processor can create accounts for handling transactions and depositing money. The investment module 170 upon execution by the processor can provide for the short-term investment of the funds held in the accounts. The charity module 180 upon execution by the processor can provide for donations and charity. The tracking module 190 upon execution by the processor can track the transaction of a user on the disclosed system and determine rewards for the user.

The interface module can provide interfaces for interacting with disclosed system, wherein a user can download and upload information through the interface. The interface can be provided as application software that can be installed on a user's device. The application software can be developed for Android, iOS, and any other known operating platform for mobile devices and computing systems. The application software can be made available through a distribution service provider, for example, Google Play operated and developed by Google, and the app store by Apple. In addition to the application software, a website-based interface can also be provided through the world-wide-web. The application software can also be provided as software-as-a-service.

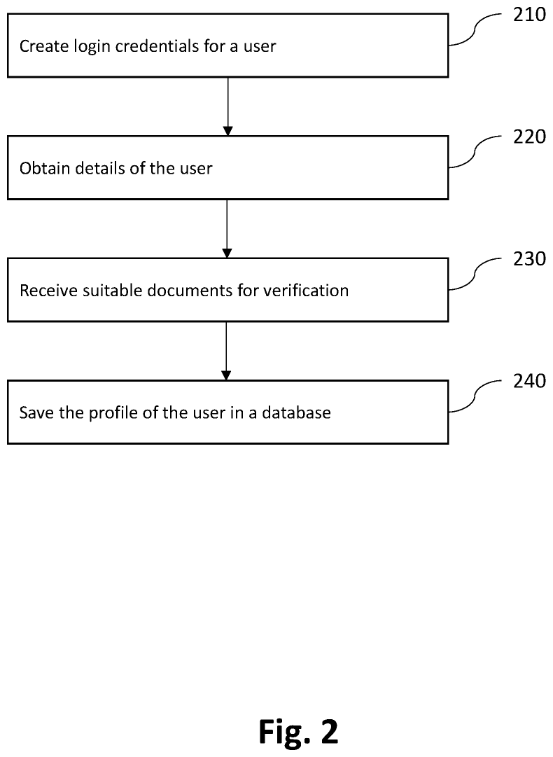

The profile module 140 can allow a user to register on the disclosed system. Referring to FIG. 2 shows an exemplary embodiment of the disclosed profile module 140. The profile module can create login credentials fora user to securely access the disclosed system through their devices, at step 210. The user device can be a laptop workstation, desktop, smartphone, tablet computer, thin client, and the like. The profile module 140 can provide a registration form through a user interface implemented on the user device. The user interface can also provide a login screen to receive login credentials and authorize the user to access the disclosed system 100. The login credentials can include a username and a password. The password can be any alphanumeric code and include symbols and the like. Biometric-based authentication and login are also within the scope of the present invention. Through the registration form, the profile module 140 can obtain information about the user, such as name, contact details, addresses, affiliations, and like, at step 220. The profile module 140 can also receive suitable documents to verify the details of the user, such as government-issued identification documents, at step 230. Any other mode of verification, such as third-party verification is also within the scope of the present invention. Moreover, the step of verification can be optional, and registration can be done without the verification of the user. The profile module 140 can then save the profile in a quarriable database that allows searching of the profiles based on keywords, at step 240. The profiles can be edited later by the user and more information can also be obtained from the user after registration.

The networking module 150 can provide a social networking platform for the users to interact with others in groups. The platform can allow users to create a message, news, articles, campaigns, and the like and post them in groups. The users on the platform can view and react to each other posts. The users can create their public pages that can be accessed outside the platform, wherein the users can provide information about themselves, the cause represented by the users, types of donations accepted, and the like. Activities of the users can be tracked and presented on the page, such as the number of causes for which the user has collected donations, hours the user has been active on the platform, date of joining of the user, and the like. The activities of the user on the platform can be tracked which can affect the rank and reputation of the user on the platform. The users can be provided with ranks, levels, badges, potentially crypto-assets, digital currency, NFTs, tokens, and the like according to their contribution. The user can share a link to their post on other social media platforms, wherein upon clicking on the like, the post on the platform can be presented. The networking module 150 can also allow the user to generate campaigns and send campaigns to directories, email lists, other social media platforms, and the like. The networking module 150 can track the response to such campaigns, and the same can be reflected on the public profile or page of the user. Besides charity, the disclosed networking module may also allow fundraising for different tasks, such as medical treatment, tuition fees, and the like causes.

The Fintech module 160 can provide for the creation/linking of bank accounts for holding the funds. For example, the user can link their bank account with their profile on the system. The Fintech module 160 can provide a payment interface through which money can be received and deposited in the linked account. The user can send actionable links, account details, QR codes, and the likes to people for donations. The actionable links can be used to make a direct donation by transferring money into the account. The Fintech module 160 may also provide a donor-advised fund account linked to their profile for any funds directed to 501(c)(3) charities. Similar accounts according to local tax rules for charities can be created by the disclosed Fintech module 160. Users can also be given a cash equivalent account for money not yet determined to ultimately be for a 501(c)(3) charity, this account may be inactive if a 501(c)(3) charity is exclusively the intended beneficiary of the platform. Thus, the Fintech module 160 can ensure compliance with local charity laws and tax-saving donations. The Fintech module 160 can stamp each transaction with details such as the source of funds, the purpose of the fund, date and time, and the like details. The Fintech module 160 can present the records of transactions through an interface. Transactions from people can be tracked including both debit and credit. Money debited from the account can similarly be tracked by the Fintech module 160 i.e., to who the money is sent, purpose, date, time, and source of fund. Fintech module 160 can link the donor and donee, for example, Mr. X donates 100 USD by transferring the amount to the account of the user. The user can transfer 50 USD of X's amount to Donee Y for the purpose with which X donated the amount. Fintech module 160 can present the interface showing both credit and debit entries, with the source and destination of funds, the purpose for which the donations were made, and the like. While there could be multiple donors from which funds are received into an account, the Fintech module 160 can provide an option to choose a donor from which funds can be transferred to the recipient of donation based on the purpose of donation. The transaction can be grouped by the cause for which the donations are received and transferred to the recipient. Each cause promoted by the user can be given a unique id and that unique id can be embedded in the transactions related to the cause. Thus, money collected for a particular cause and distribution of the money in charities can be tracked using the unique id for that cause. Moreover, the Fintech module 160 may automatically regulate the legal compliance for charities and donations, such as 501(c)(3) charities and people/organizations eligible to receive the 501(c)(3) charity. The automation of legal compliance allows the user to focus more on promoting the cause for collecting money for charities. Also, the Fintech module 160 can allow receiving payments through different sources, such as local and international direct bank transfers, credit cards, debit cards, and online payment systems such as PayPal™. The Fintech module 160 can also provide for receiving digital currency, such as Bitcoins, and conversion of the digital currency into the local currency. The Fintech module 160 can also generate suitable receipts for payments to avail of any tax benefits. The fintech module can provide for receiving and making payments and transfers of and from assets on the investment module to 501(c)(3) charities, individuals, individuals as recipients of distribution from a 501(c)(3) charity.” And its ability to track the value of those investments.

The investment module 170 may provide for investing the money in accounts of different users so that to gain income that can be further used for charity and rewards. The investment module 170 may take into consideration distinct factors while investing money from an account of a user, such as the distribution of money for charity and regulatory compliance. The users can specify due dates for payments, dates of recurring payments, and the like. Investment module 170 can invest the money for the duration in which the money will remain unused in the account. All the rules of investing money can be predefined and the process of investments can be automated, such as where and when the money can be invested. For example, a certain amount of money is held in the account of the user that has to be paid in tuition fee of a student as a charity. A portion of the held money is debited each month to pay the monthly fee on behalf of the student. The investment module 170 can receive the total amount of money held for the cause i.e., payment of tuition fee, amount to be paid each month, and due date, based on these factors, the money held can be invested by the investment module 170. From the gains, additional charities can be made, and rewards can be paid to the user. Moreover, this additional benefit can also be transferred to the student.

The charity module 180 can allow persons and organizations, referred to herein as recipients, willing to receive charities to register themselves on the disclosed system 100. The charity module 180 can assign a unique ID to each recipient. Bank account details of recipients can also be taken to which the money can be transferred.

The tracking module 190 can track the activities of the user, such as the creation and promotion of causes, and based on the activities, suitable rewards can be provided to the users.

In one implementation, the Fintech module may allow the donations from donors into User Account Held in Donor Advised Fund (which is an investment account considered in 501(c)(3)) but user still has agency over investments and grants that get paid out to: Charity or other DAFs/users.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method to fundraising, the method implemented within a system comprising a processor and a memory, the method comprising the steps of:
generating, by an interface module, an interface for interacting with the system;
creating, by a profile module implemented with the system and upon execution by the processor, a profile of a user, the profile comprises a name and a contact detail of the user;
associating, by a fintech module implemented with the system and upon execution by the processor, one or more cash accounts to the profile for receiving funds from one or more donors;
providing, by the fintech module, a payment interface for electronically receiving the funds from the one or more donors;
populating, by a networking module, a campaign for presenting a cause to the one or more donors for receiving the funds, wherein the campaign has a unique id, wherein the payment interface is coupled to the campaign; and
recording transactions relating to transfer of funds from the one or more donors in response to the campaign, wherein the transactions are tagged with the unique id of the campaign.

2. The method according to claim 1, wherein the method further comprises the steps of:
transferring a portion of cash amount from the one or more cash accounts to one or more investment products automatically based on predetermined instructions.

3. The method according to claim 1, wherein the method further comprises the steps of:
providing an interface for transferring funds to one or more recipients of charity.

4. The method according to claim 3, wherein the method further comprises the steps of:
selecting a donor from the one or more donors from whom the funds are transferred to the one or more recipients.

5. The method according to claim 1, wherein the method further comprises the steps of:
receiving, by the profile module, identification documents, of the user for verification.

6. The method according to claim 1, wherein the method further comprises the steps of:
providing, by the networking module, a main page associated with the user, the main page comprises the name and the contact detail of the user, information of the campaign, and the transactions associated with the campaign, wherein the transactions are tracked using the unique id of the campaign.

7. The method according to claim 1, wherein the method further comprises the steps of:
tracking activities of the user in relation to the system; and
generating rewards for contribution of the user based on the activities.

8. The method according to claim 1, wherein the method further comprises the steps of:
automatically generating receipts for the funds received from the one or more donors to avail of any benefits.

9. A system for fundraising, the system comprising a processor and a memory, the system configured to implement a method comprising the steps of:
generating, by an interface module, an interface for interacting with the system;
creating, by a profile module implemented with the system and upon execution by the processor, a profile of a user, the profile comprises a name and a contact detail of the user;
associating, by a fintech module implemented with the system and upon execution by the processor, one or more cash accounts to the profile for receiving funds from one or more donors;
providing, by the fintech module, a payment interface for electronically receiving the funds from the one or more donors;
populating, by a networking module, a campaign for presenting a cause to the one or more donors for receiving the funds, wherein the campaign has a unique id, wherein the payment interface is coupled to the campaign; and
recording transactions relating to transfer of the funds from the one or more donors in response to the campaign, wherein the transactions are tagged with the unique id of the campaign.

10. The system according to claim 9, wherein the system is further configured to implement the steps of:
transferring a portion of cash amount from the one or more cash accounts to an investment product automatically based on predetermined instructions.

11. The system according to claim 9, wherein the system is further configured to implement the steps of:
providing an interface for transferring the funds to one or more recipients of charity.

12. The system according to claim 11, wherein the system is further configured to implement the steps of:
selecting a donor from the one or more donors from whom the funds are transferred to the one or more recipients.

13. The system according to claim 9, wherein the system is further configured to implement the steps of:
receiving, by the profile module, identification documents, of the user for verification.

14. The system according to claim 9, wherein the system is further configured to implement the steps of:
providing, by the networking module, a main page associated with the user, the main page comprises the name and the contact detail of the user, information of the campaign, and the transactions associated with the campaign, wherein the transactions are tracked using the unique id of the campaign.

15. The system according to claim 9, wherein the system is further configured to implement the steps of:
tracking activities of the user in relation to the system; and
generating rewards for contribution of the user based on the activities.

16. The system according to claim 9, wherein the system is further configured to implement the steps of:
automatically generating receipts for the funds received from the one or more donors to avail of any benefits.
